(19) United States
(12) Patent Application Publication
(10) Pub. No.: US 2003/0046246 A1
(43) Pub. Date: Mar. 6, 2003

(54) Blocking server

(75) Inventors: Dieter Klumpp, Stuttgart (DE); Andreas Pfitzmann, Dresden (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/228,202

(22) Filed: Aug. 27, 2002

(30) Foreign Application Priority Data
Sep. 6, 2001 (DE) 101 43 876.1

(51) Int. Cl. G06F 17/60

(52) U.S. Cl. 705/64

(57) ABSTRACT

The invention relates to a method for supporting the blocking of credit or bank cards of a card user, and a blocking server, a device and a bank server to execute the method. A card-individual blocking code is stored in a storage medium. Upon a control command from the card user, the blocking code is read from the storage medium and a card-individual blocking code is sent over a communications network to a central blocking server. The received blocking code is verified by the central blocking server. Upon positive verification, the blocking server prompts the blocking of the credit or bank card related to the blocking code.

The invention is based on a priority application DE 101 43 876 which is hereby incorporated by reference.

### BACKGROUND OF THE INVENTION

The invention relates to a method for supporting the blocking of credit or bank cards of a card user, and a blocking server, a device and a bank server to execute the method.

The invention assumes the usual current manner for the blocking of credit or bank cards.

If a card user wants to have a credit or bank card blocked, for example because it has been stolen from him, he has to call a special service call number for the relevant bank or credit institution. He then identifies the credit or bank card to be blocked to the service staff of the bank or credit institution The service staff member then arranges the blocking of the credit or bank card, by input of a corresponding control command to the computer system of the relevant bank or credit institution.

This customary current procedure has the disadvantage that it involves high costs.

### SUMMARY OF THE INVENTION

The invention is based on the object of enabling a cost-effective and efficient blocking of credit or bank cards. This object is achieved with a method to support the blocking of credit or bank cards of a card user wherein a card-individual blocking code is stored in a storage medium, wherein the blocking code is read from the storage medium upon a control command from the card user and a card-individual blocking code is sent via the communications network to a central blocking server, wherein the received blocking code is verified by the central blocking server, and wherein upon positive verification, the blocking server prompts the blocking of the credit or bank card related to the blocking code.

This object is further achieved with a blocking server to support the blocking of credit or bank cards of a number of card users, the blocking server being equipped with an interface unit for connecting the blocking server to a communications network,

wherein the blocking server is equipped with a control unit, which is developed such that when it receives a card-individual blocking code over the interface unit, it performs a verification of the card-individual blocking code, and upon positive verification prompts the blocking of the credit or bank card related to the card-individual blocking code.

Tlhis object is further achieved with a device to support the blocking of credit or bank cards of a card user, wherein the device is equipped with a storage medium, in which one or more card-individual blocking codes of the card user are stored, and wherein the device is equipped with a control unit, which is developed such that upon a control command from the card user, it reads one or more of the blocking codes from the storage medium and prompts the sending of card-individual blocking codes over a communications network to a central blocking server.

This object is further achieved with a bank server to support the blocking of credit or bank cards of card users wherein the bank server is developed such that it determines for a credit or bank card a card-individual blocking code and data for verification of the card-individual blocking code, and the bank server is further developed such that it prompts the sending of the data for verification of the card-individual blocking code to a central blocking server.

As well as credit or bank cards in the stricter sense, the invention is also applicable to other cards, whose loss and subsequent unauthorized use can be detrimental to the card user. Such cards for example are company identity cards and key cards, cards of hotels, car hire firms and stores, based on which special advantages are granted, also discount cards and so on. In the sense of the invention these are regarded as credit or bank cards. It is thus advantageous to provide a central blocking server for all these cards.

The advantage of the invention is that a fast and user-friendly blocking of credit or bank cards is enabled.

The invention further prevents third parties who are not users of these credit or bank cards from being able to block them.

The invention further ensures that on the central blocking server no data is stored by which a conclusion is possible about the number and nature of a card user's credit or bank cards. A further security advantage arises from the fact that in the blocking server, only information by means of which cards can be blocked is present. Thus the blocking server can only block cards.

Advantageous developments of the invention can be taken from the subclaims.

The invention will be further described with reference to several examples of embodiments and with the help of the accompanying drawings.

### BRIEF DESCRIPTION OF THE DRAWINGS

FIG. 1 shows a block diagram of a system with a blocking server according to the invention and with several devices and bank servers according to the invention.

FIG. 2 shows a functional representation of the blocking server and of a device as in FIG. 1.

### DETAILED DESCRIPTION OF THE INVENTION

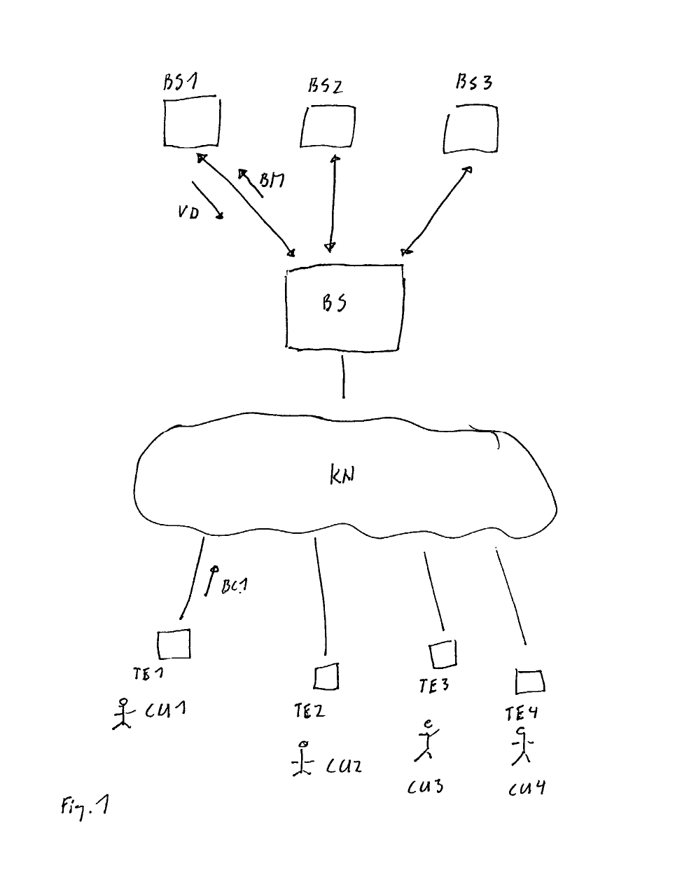

FIG. 1 shows several bank servers BS1 to BS3, a blocking server BS and several devices TE1 to TE4, each of which is assigned to a card user CU1, CU2, CU3 or CU4.

The bank servers CS1 to CS3 are each assigned to a bank or a credit institution that issues bank or credit cards to customers.

The bank servers BS1 to BS3 are formed here from one or more interconnected computers, the peripheral components assigned to the computers and the software running on these computers. The bank servers BS1 to BS3 are part of the computer system of the related bank or credit institution in each case. They are thus able to prompt the blocking of bank and credit cards of the particular bank or credit institution.

The bank servers BS1 to BS3 now determine a card-individual blocking code for each of the bank or credit cards issued by the particular bank or credit institution. These blocking codes are communicated to the respective users of the bank or credit cards and stored by these in a storage medium. These blocking codes can be communicated by post or by electronic means, for instance by email or SMS (=short message service). In the second case, an automatic transfer into the storage medium is also possible. For the electronic communication, encrypted transmission of the blocking code is advantageous.

A further possibility is that the established blocking codes are communicated by the bank servers BS1 to BS3 to a server of an independent service operator. This service operator stores all the blocking codes allocated to a card user in a storage medium. The blocking codes for all the card user's credit and bank cards are thus stored in the storage medium. The storage medium is then sent to the related card user.

As well as the blocking codes, the bank servers BS1 to BS3 also determine data for verification of the particular card-individual blocking code. In the simplest case this data contains the blocking code and further data, for example a customer identifier and an identifier of the particular bank or credit institution.

The bank servers BS1 to BS3 send the established data for verification of card-individual blocking codes to the central blocking server BS. It is advantageous here that this data is sent encrypted to the blocking server BS.

The blocking code verification data sent by the bank servers BS1 to BS3 to the central blocking server BS, for example the data VD, is then stored in the blocking server BS for verification of blocking codes.

A further possibility for determining card-individual blocking codes and data for verification of card-individual blocking codes is the use of one-way functions: Between the participants, thus for example between the bank server BS1 and the blocking server BS, a one-way function F is agreed, i.e. the one-way function is known to both the blocking server BS and the bank server BS1. The function F is a function that can be efficiently computed in the “normal” direction, but cannot be computed in the other direction without unacceptable effort, i.e. cannot be inverted.

The bank server BS1 chooses a random value W and forms the value X=F(W). It then sends the value X together with the customer identifier and an identifier for the particular bank to the blocking server BS as data for verification of the card-individual blocking code. The value W is communicated to the respective user of the bank or credit cards as a blocking code, and stored in a storage medium. The blocking server BS stores the value X together with the further data and, by means of this data and the function F, is thus able to verify a blocking code submitted to it. When the blocking code BC1 is submitted, the blocking server BS computes the function F(BC1) and checks whether F(BC1) actually gives the value X.

It is advantageous here to agree that the message that triggers the blocking is archived by the blocking server BS and must be presented in the event of a dispute.

This manner of generating and verifying blocking codes has the advantage that nobody, not even the blocking server BS, which does know the function F and the value W, is able to compute the value W and to block the card with it.

The value W can also be composed from a random number, a customer identifier and an identifier for the relevant bank. This has the advantage that information about the customer identifier and bank identifier is only present in the blocking server BS in a form that the blocking server BS cannot decode.

It is further possible that blocking code and data for verification of blocking codes are generated by means of a signature key pair:

The bank server BS1 generates a signature key pair, for example. The blocking server BS receives the public key, and the private key is stored as an “internal” blocking code in the card user's storage medium. Upon a control command from the card user, the private key is used to encrypt a blocking message, for instance containing date and time, and a card-individual “external” blocking code is thus computed. This “external” blocking code is likewise stored in the storage medium, read from the storage medium and then sent to the blocking server BS. This verifies the blocking code by decoding the blocking message using the public key.

It is further possible that blocking code and data for verification of the card-individual blocking code form a key pair, from which relationship the aforementioned data is produced.

The devices TE1 to TE4 are advantageously mobile radiotelephones. However, it is also possible that the devices TE1 to TE4 are other telecommunication terminals. It is further also possible that for example a waterproof clock is involved, which performs the corresponding functions described below, or that a computer with an interface unit for connection to a communications network is involved.

The devices TE1 to TE4 each have a storage medium in which one or more card-individual blocking codes are stored. This storage medium can for instance be a SIM card. It is also possible that the entire device TE1 is implemented as a chip card.

It is naturally also possible that two or more devices are assigned to a card user, for example a mobile radiotelephone and a computer.

The communications network KN is a telephone network, an ISDN network for example. This telephone network can incorporate several subnetworks, which for example involve mobile telephony networks or are assigned to the various network providers. But the communications network KN can also be a data network, which for example enables communication through the TCP/IP protocol stack.

It is further possible that within the communication network, services are provided which forward messages with blocking codes to the blocking server BS. For example, such a service can forward all calls that are directed to several different service call numbers, to a single call number assigned to the blocking server. This service can be implemented for instance with the IN technology (IN=Intelligent Network) and also be an integral part of the blocking server BS.

The blocking server BS prompts the blocking of the credit or bank cards related to a blocking code communicated to it. For this, the blocking server BS can be responsible for the blocking of all credit or bank cards of one bank or credit institution. However, it is more advantageous that the blocking server BS can centrally prompt the blocking of credit or bank cards of several credit institutions and/or or banks, and is thus responsible for the blocking of the credit or bank cards of a number of banks or credit institutions. Thus for example the blocking of all a card user's credit or bank cards can be initiated centrally through a single call number.

The blocking server BS is formed from one or from several interconnected computers with peripheral components, a software platform based on these computers and application programs running on them. The blocking server's functions described below are performed when the application programs run on the system platform.

The blocking server BS can be implemented as an IN server (IN=Intelligent Network, SCP=Service Switching Point), for example, or as an Internet server.

To support the blocking of credit or bank cards of the card user CU1, the following procedure is executed:

For each credit or bank card of the card user CU1, a card-individual blocking code is stored in a storage medium of the device TE1. If one of these credit or bank cards is to be blocked, the assigned blocking code, here the blocking code BC1, is read from the storage medium upon a control command from the card user CU1 and sent via the communications network KN to the central blocking server BS. The blocking code BC1 is verified by the central blocking server BS. Upon positive verification, the blocking server BS prompts the blocking of the credit or bank card related to the blocking code BC1. To do this, a blocking message BM is sent to the bank server BS1, for example.

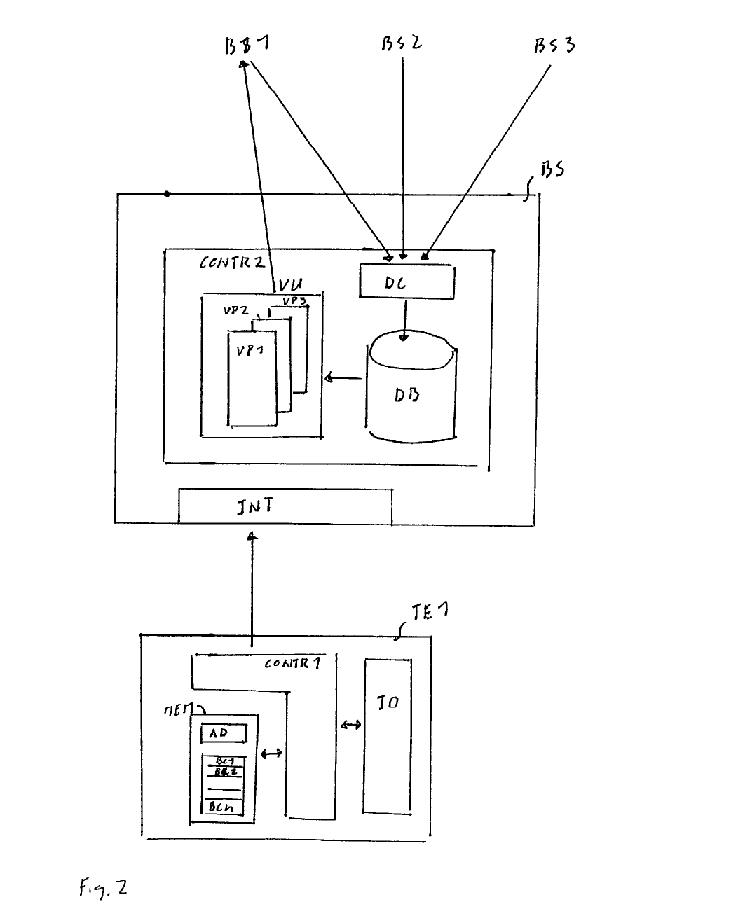

The exact layout of the blocking server BS and the devices TE1 to TE4 is explained below with reference to FIG. 2.

FIG. 2 shows the blocking server BS and the device TE1 as an example for the devices TE1 to TE4.

The device TE1 presents a storage medium MEM, a control unit CONTR1 and an input/output unit IO.

The storage medium MEM is formed for example by a SIM card, a chip card, a memory chip or a hard disk. The storage medium MEM can naturally also be an optical storage medium or a combination of different storage media.

One or more card-individual blocking codes of the card user CU1 are stored in the storage medium MEM. Such a blocking code consists for instance of a 12-digit numeric code. In this context, card-individual means that each of the blocking codes is the individual blocking code of one particular credit or bank card. Here on the storage medium MEM, n card-individual blocking codes BC1 to BCn are stored for n credit or bank cards of the card user CU1. It is also possible that the blocking codes BC1 to BCn—as already mentioned above—are internal blocking codes (e.g. keys), from which external blocking codes (e.g. messages encrypted with this key) are generated.

It is advantageous here that for each blocking code a short description is also stored in the storage medium MEM, of the credit or bank card to which the particular blocking code is assigned. This description can include the type of credit or bank card, for instance (Visa, EC, . . . ), or the card number.

It is advantageous here that the one or more card-individual blocking codes are stored encrypted in the storage medium MEM.

It is further advantageous that the communication address of the blocking server BS, here a communication address AD, is also stored in the storage medium MEM.

The input/output unit IO provides the user interface for the card user CU1, and thus serves for the input and output of data to the card user CU1. It consists for example of a keypad and a graphic display unit, such as a liquid crystal display. The control unit CONT1 is formed from a CPU with memory and peripheral components, and the software running on this CPU. In the execution of this software on the CPU, the following functions are performed:

Upon a control command of the card user CU1, received over the input/output unit IO, one or more of the blocking codes are read from the storage medium MEM and the sending of the retrieved blocking code over the communications network KN to the central blocking server BS is prompted. In addition it is possible that during the retrieval, external blocking codes are generated from internal blocking codes.

It is advantageous here that the control unit CONTR1 enables the card user CU1 to select one or more from his credit or bank cards with control commands. Thus for example, upon a control command from the card user CU1, the control unit CONTR1 shows on a graphic display a list of the credit and/or bank cards whose blocking codes are stored on the storage medium MEM. The user can then select one or more of these credit and/or bank cards, for instance by scrolling and marking. The control unit CONTR1 then initiates the retrieval and sending of those blocking codes that are assigned to the selected credit and/or bank cards.

To send the blocking codes to the blocking server BS, the control unit CONTR1 sets up a connection over the communications network KN to the blocking server BS. The control unit CONTR1 here likewise takes the relevant communication address AD from the storage medium MEM. The control unit CONTR1 then communicates the blocking code(s) over this connection, in DTMF coding for example. It is also possible to transmit the blocking code(s) by SMS to the blocking server BS. It is naturally also possible that the blocking codes are transmitted as data packets via a data network to the blocking server BS.

It is advantageous here that the control unit CONTR1 sends the retrieved blocking codes in encrypted form to the central blocking server BS.

It is possible that the control unit CONTR1 and the storage unit MEM together form one unit, as a chip card for example.

The blocking server BS presents an interface unit INT and a control unit CONTR2.

The interface unit INT serves to connect the blocking server BS to the communications network KN. This is for example an interface card, which enables the connection of the blocking server BS to the communications network KN.

The control unit CONTR2 is formed from applications programs running on the system platform of the blocking server; when running on the system platform they perform functions VU and DC from a functional angle, as well as providing a database DB.

The database DB serves for storing blocking code verification data.

The function DC stores data received from the bank servers BS1 to BS3, for verification of blocking codes, in the database DB.

The function VU verifies blocking codes by accessing the database DB, and prompts the blocking of credit or bank cards. It can present several processes, here for example the processes VP1 to VP4. If the control unit CONTR2 receives a card-individual blocking code over interface unit INT, then the function VU starts a process, for example process VP1, which performs a verification of the card-individual blocking code. For a positive verification, the process VP1 prompts the blocking of the credit or bank card related to the card-individual blocking code. The process does this by prompting the sending of a blocking message BN to the corresponding bank server, for example the bank server BS1. Process VP1 is then terminated.

For verification of the blocking code, the process VP1 here accesses the blocking code verification data stored in the database DB. In so doing, for example, it correlates a blocking code with all blocking code verification data stored in the database DB. If it is thereby ascertained that a blocking code is a valid blocking code for a credit or bank card, the result of the verification is positive.

It is advantageous that during verification the process VP1 establishes the credit institution or bank that issued the credit or bank card to which the card-individual blocking code is assigned.

It is further advantageous that during verification the process VP1 establishes a customer identifier for the card user of the credit or bank card to which the card-individual blocking code is assigned.

The process VP1 then prompts the blocking of the credit or bank card, by prompting the sending of a blocking message with the established customer identifier to the established credit institution or bank.

1. Method to support the blocking of credit or bank cards of a card user, wherein a card-individual blocking code is stored in a storage medium, wherein the blocking code is read from the storage medium upon a control command from the card user and a card-individual blocking code is sent via the communications network to a central blocking server, wherein the received blocking code is verified by the central blocking server, and wherein upon positive verification, the blocking server prompts the blocking of the credit or bank card related to the blocking code.

2. Method as claimed in claim 1, wherein the blocking server centrally prompts the blocking of credit or bank cards of several credit institutions and/or banks.

3. Method as claimed in claim 1, wherein data for verifying blocking codes is communicated from bank servers to the central blocking server and stored in the blocking server.

4. Method as claimed in claim 1, wherein said card-individual blocking code and said data for verifying said card-individual blocking code are generated by means of a signature key pair, said card-individual blocking code being derived from the private key of said signature key pair and said data for verifying said card-individual blocking code being derived from said public key of said signature key pair.

5. Blocking server to support the blocking of credit or bank cards of a number of card users, the blocking server being equipped with an interface unit for connecting the blocking server to a communications network,
wherein the blocking server is equipped with a control unit, which is developed such that when it receives a card-individual blocking code over the interface unit, it performs a verification of the card-individual blocking code, and upon positive verification prompts the blocking of the credit or bank card related to the card-individual blocking code.

6. Blocking server as claimed in claim 5, wherein the control unit is equipped with a database for storing blocking code verification data, and wherein the control unit is further developed such that it stores blocking code verification data received from bank servers in the database and accesses the blocking code verification data stored in the database for the verification of blocking codes.

7. Blocking server as claimed in claim 5, wherein the control unit is further developed such that during verification it establishes the credit institution or bank that issued the credit or bank card to which the card-individual blocking code is assigned.

8. Blocking server as claimed in claim 5, wherein the control unit is further developed such that during verification it establishes a customer identifier for the card user of the credit or bank card to which the card-individual blocking code is assigned.

9. Blocking server as claimed in claim 7, wherein the control unit is further developed such that in the blocking of the credit or bank card it prompts the sending of the established customer identifier to the established credit institution or bank.

10. Device to support the blocking of credit or bank cards of a card user, wherein the device is equipped with a storage medium, in which one or more card-individual blocking codes of the card user are stored, and wherein the device is equipped with a control unit, which is developed such that upon a control command from the card user, it reads one or more of the blocking codes from the storage medium and prompts the sending of card-individual blocking codes over a communications network to a central blocking server.

11. Device as claimed in claim 10, wherein the device is a mobile radiotelephone.

12. Device as claimed in claim 10, wherein the device is a computer with an interface unit for connection to a communications network.

13. Device as claimed in claim 10, wherein the storage medium is a SIM card.

14. Device as claimed in claim 10, wherein the control unit is further developed such that it enables the card user to select one or more from his credit and/or bank cards with control commands, and wherein it prompts the retrieval and sending of the blocking codes that are assigned to the selected.credit and/or bank cards.

15. Device as claimed in claim 10, wherein the one or more card-individual blocking codes are stored encrypted in the storage medium.

16. Device as claimed in claim 10, wherein the control unit is further developed such that it sends the retrieved blocking codes in encrypted form to the central blocking server.

17. Device as claimed in claim 10, wherein the control unit is further developed such that it reads a card-individual internal blocking code from the storage medium, and generates a card-individual external blocking code from this card-individual internal blocking code and prompts the sending of this external blocking code over the communications network to the central blocking server.

18. Bank server to support the blocking of credit or bank cards of card users, wherein the bank server is developed such that it determines for a credit or bank card a card-individual blocking code and data for verification of the card-individual blocking code, and the bank server is further developed such that it prompts the sending of the data for verification of the card-individual blocking code to a central blocking server.
